(19) United States
(12) Patent Application Publication
(10) Pub. No.: US 2018/0101914 A1
(43) Pub. Date: Apr. 12, 2018

(54) SYSTEMS, METHODS AND MACHINE-READABLE MEDIUMS FOR DATA MANAGEMENT AND PAYMENT PROCESSING

(71) Applicant: ESCOLHALEGAL, LLC, MANHATTAN BEACH, CA (US)

(72) Inventors: EHAB SAMUEL, MANHATTAN BEACH, CA (US); LUIZ FERNANDO CALDAS BARROZO, RIO DE JANEIRO (BR)

(21) Appl. No.: 15/728,507

(22) Filed: Oct. 10, 2017

Related U.S. Application Data
(60) Provisional application No. 62/406,371, filed on Oct. 10, 2016.

(51) Int. Cl. G06Q 40/00; G06Q 20/40; G06Q 30/04; G06Q 20/10

(52) U.S. Cl. CPC G06Q 40/125; G06Q 20/401; G06Q 20/065; G06Q 20/102; G06Q 2220/00; G06Q 30/04

(57) ABSTRACT

Systems, methods and machine-readable mediums for processing transaction data on a ledger to facilitate collection of account receivables are provided. The system may include one or more processors programmed to generate, for a first computing device associated with a first ledger account, an electronic invoice based on a transaction data on an account receivable, transmit the electronic invoice to a second computing device associated with a third party account, update, in an encrypted ledger, to reflect a transfer of a first payment using a digital wallet, and generate a report for the first ledger account to reflect the transfer of the first payment and on their respective transaction data associated with at least one of assets, liabilities, equity, cash flow, revenue and expenses.

### CROSS REFERENCE To RELATED APPLICATION

This patent document claims the benefit of and priority to U.S. Provisional Application Ser. No. 62/406,371, filed Oct. 10, 2016, the contents of which are incorporated herein by reference in their entirety and are to be considered a part of the specification.

### FIELD

The present disclosure relates generally to systems, methods and machine-readable mediums for electronically processing transactions. More particularly, this disclosure relates to systems, methods and machine-readable mediums for processing cryptographic transactions to collect account receivables using a digital wallet, and electronically reconciling with a first data from a point-of-sale system, a client computer and/or a financial record server.

### BACKGROUND

Traditionally, businesses collect payments for accounts receivables by invoicing a particular client and awaiting payment via check, cash or wire transfer. The records of income, as well as debts, are then submitted to an accountant to determine the taxes for a given period of time. While some software, such as Quicken® or Quickbooks®, facilitate limited personal and business finance and accounting, none of the software solutions automatically reconciles financial data from multiple sources and facilitates payment of account receivables for the software users. Accordingly, improved accounting software would be advantageous.

### SUMMARY

Systems, methods and machine-readable mediums for processing cryptographic transactions on a ledger (e.g., blockchain) to facilitate collection of account receivables are provided. Embodiments of the present disclosure may include systems, methods and machine-readable mediums adapted to, using one or more processors, to generate a ledger having a plurality of ledger accounts, wherein at least one ledger account comprises a plurality of transaction data, the transaction data arranged in data fields comprising assets, liabilities, cash flow, account receivables, revenue and/or expenses of the ledger account. In one embodiment, the ledger is distributed to a plurality of computing nodes in a network. The systems, methods and machine-readable mediums may be adapted to, using the one or more processors, to receive, from a first computing device associated with a first ledger account, a first data entry on a first account receivable for an amount due from a third party account, generate an electronic invoice based on the first data entry, and transmit the electronic invoice to a second computing device, the second computing device associated with the third party account. Further, the systems, methods and machine-readable mediums may be adapted to, using the one or more processors, to receive, from the second computing device, a request code to transfer a first payment (e.g., with fiat or cryptographic currency), the first payment being equal to or less than the amount due. In one embodiment, the one or more processors may be further programmed to update the first ledger account to reflect the transfer of the first payment. Further, in another embodiment, the one or more processors may be programmed to generate a first report reflecting the update to the first ledger account based on the transfer of the first payment, the first report is selected from a group consisting of a balance sheet, a tax report, a detailed statement of transactions, an accounting report, an income statement, and a cash flow statement.

In yet another embodiment, the one or more processors may be programmed to generate payroll information for a predetermined period of time, the payroll information associated with the first ledger account, and transmit, over the network, the payroll information associated with the first ledger account for display on a client display device. In one embodiment, the ledger is distributed to a plurality of computing nodes in a network, the computing nodes recording a change in ownership of the first payment from the third party account to the first ledger account upon receipt of the request code. The first computing device and/or the second computing device may be one of the plurality of computing nodes.

In one embodiment, the one or more processors is further programmed to hash the transaction data using a hashing algorithm prior to recording in the ledger. Further, in one embodiment, the one or more processors may be further programmed to verify that the third party account owns the cryptographic currency prior to recording, in the ledger, the change in ownership from the third party account to the first ledger account.

Embodiments of the present disclosure may also include systems, methods and machine-readable mediums for managing and/or reconciling financial data of a business, entity or individual. The systems, methods and machine-readable mediums may be adapted to integrate and/or reconcile financial data from a point-of-sale system, a client computer, and/or a financial record server, and generate one or more reports, such as a balance sheet, a tax report, a detailed statement of transactions, an accounting report, an income statement, and a cash flow statement. The report(s) may then be submitted electronically to a second server (i.e. government server) to report tax liability. In one embodiment, the systems, methods and machine-readable mediums may be further adapted to integrate electronic invoicing, payroll processing, dynamic website generation and other business applications.

Methods for creating a report are also provided. In one embodiment, the method comprises: electronically receiving, from a point-of-sale system, a first data associated with an expense for a first commercial transaction, the first data comprising a first transaction date, a first transaction amount, and a first transaction identifier; electronically receiving, from a client computer, a first request code to transmit an electronic invoice associated with an account receivable, the first request code comprising a second data associated with a second commercial transaction, the second data comprising a second transaction date, a second transaction amount, and a second transaction identifier; in response to the receipt of the first request code, transmitting on a transmission medium, the electronic invoice comprising the second data associated with the second commercial transaction; assigning a first ledger code to the first data based on the first transaction identifier and a second ledger code to the second data based on the second transaction identifier; and electronically generating the report associated with a client financial account, wherein the client financial account has been reconciled with the first transaction amount based on the first ledger code and the second transaction amount based on the second ledger code.

Computer-implemented methods for data management are also provided. In one embodiment, a method may include electronically receiving, from a point-of-sale system, a first data associated with a first commercial transaction, and electronically receiving, from a client computer, a first request code to transmit an electronic invoice comprising a second data associated with a second commercial transaction. The first data may comprise a first transaction date, a first transaction amount, and a first transaction identifier, while the second data may comprise a second transaction date, a second transaction amount, and a second transaction identifier. The method may further include transmitting on a transmission medium the electronic invoice comprising the second data associated with the second commercial transaction; and displaying, on a display device, a generated report based on the first data and the second data. The report is selected from a group consisting of a financial report, a balance sheet, a tax statement, a payroll statement, a detailed statement of transactions, an accounting report, an income statement, and a cash flow statement.

In one embodiment, the method further includes encoding, using an encoder, the first data and the second data, and transmitting, on the transmission medium, the encoded first data and the encoded second data to a third party server, wherein the third party server decodes the encoded first data and encoded second data, and automatically generates the report based on the encoded first data and the encoded second data. The method may further include storing, on a storage medium, the generated report, and retrieving the generated report from the storage medium for display on the display device. The method may also include, prior to displaying on the display device, automatically generating the report by at least one processor based on the first data and the second data; storing, on a storage medium, the generated report; and retrieving the generated report from the storage medium for display on the display device.

In some embodiments, the method further comprises, in response to the receipt of the first request code to transmit an electronic invoice, transmitting an activation code to process payment of the second transaction amount via a payment gateway, and in response to a user activation of the activation code, processing payment of the second transaction amount via the payment gateway.

In another embodiment, the method further comprises electronically receiving, from the client computer, data entries associated with a plurality of commercial transactions; each data entry comprising a data entry transaction date, a data entry transaction amount, and a data entry transaction identifier. The method may further include electronically receiving, from a financial record server, financial institution data associated with a client financial institution account, each financial institution data comprising a financial institution data transaction date, a financial institution data transaction amount, and a financial institution data transaction identifier. Prior to displaying on the display device, the computer-implemented method may include automatically generating the report based on the first data, the second data, the plurality of data entries, and the financial institution data; storing, on a storage medium, the generated report; and retrieving the generated report from the storage medium and transmitting to the display device for display.

The method may also include automatically transmitting, over the transmission medium, the generated report to a second server to maintain a record of tax liability, and/or, in one embodiment, automatically receiving, from the second server, a tax statement from the second server based on the generated report. In one embodiment, the method may include dynamically generating, using at least one processor, a client website upon receipt of one or more client selections from the client computer. In yet another embodiment, the method may include receiving, from the client computer, a second request code to determine a payroll associated with a client account for a specific period; based on the second request code, determining using at least one processor, payroll information associated with the client account; and displaying, on the display device, the payroll information associated with the client account.

In some embodiments, the first and second ledger codes are assigned using a conversion table. In some embodiments, the first and second ledge codes are assigned using a chart of accounts. In a specific embodiment, the second server may be a government server. Although the specific embodiment described relates to taxes, it should be understood that other fees may be similarly recorded (e.g., electronic transaction fees).

Systems for data management are also provided. In one embodiment, a system includes a transceiver and one or more processors. The transceiver may be configured to receive, over a network, one or more encoded data associated with a plurality of commercial transactions, wherein the encoded data is transmitted from one or more of a point-of-sale system, a client computer, and a financial record server, the encoded data comprising a transaction date, a transaction amount, and a transaction identifier. The one or more processors may be electrically coupled to the transceiver and programmed to: decode the encoded data, automatically generate a report based on the encoded data, the report is selected from a group consisting of a balance sheet, a tax report, a detailed statement of transactions, an accounting report, an income statement, and a cash flow statement, and automatically transmit, over the network, the generated report to a second server to create or update a record of tax liability.

In one embodiment, the transceiver may be further configured to receive, from the client computer, a request code to transmit an electronic invoice to a recipient email address, and wherein the one or more processors may be further programmed to generate the electronic invoice based on the request code, and to transmit the generated electronic invoice to the recipient email address. In another embodiment, the one or more processors may be further programmed to automatically receive, from the second server, a tax statement based on the generated report. In yet another embodiment, the one or more processors may be further programmed to receive, over the network, one or more client selections of a website design, and dynamically generate a client website based upon the one or more client selections.

In yet other embodiments, the transceiver is further configured to receive, from the client computer, a request code to transmit an electronic invoice to a recipient email address, and wherein the one or more processors is further programmed to obtain a generated electronic invoice based on the request code, and to transmit the generated electronic invoice to the recipient email address.

In some embodiments, the transceiver may be further configured to receive, from the client computer, code instructions to determine a payroll for a predetermined period of time, the code instructions associated with a client account, and the one or more processors may be further programmed to, in response to receiving the code instructions to determine a payroll, obtain generated payroll information associated with the client account, and transmit, over the network, the payroll information associated with the client account for display on a client display device.

In one embodiment, the system for data management may include a transceiver, a storage medium and one or more processors. The transceiver may be configured to receive, from a client computer over a network, code instructions to determine a payroll for a predetermined period of time, the code instructions associated with a client account. The storage medium may comprise data associated with a plurality of commercial transactions, wherein the data is transmitted from one or more of a point-of-sale system, a client computer, and a financial record server, the data comprising a transaction date, a transaction amount and/or a transaction identifier. The one or more processors may be electrically coupled to the transceiver and the storage medium, the one or more processors programmed to: generate payroll information associated with the client account, retrieve the data from the storage medium, and generate a report based on the retrieved data and the payroll information, the report is selected from a group consisting of a balance sheet, a tax report, a detailed statement of transactions, an accounting report, an income statement, and a cash flow statement.

In some embodiments, the one or more processors may be further programmed to transmit, over the network, the payroll information associated with the client account to display on a client display device. The one or more processors may be further programmed to transmit, over the network, payment instructions to the financial record server based on the generated payroll information. Also, the one or more processors may be further programmed to automatically transmit, over the network, the generated report to a second server to report tax liability, and/or automatically receive, from a second server, a tax statement based on the generated report.

In yet another embodiment, the system for data management includes a transceiver, a storage medium and one or more processors. The transceiver may be configured to receive, from a client computer over a network, code instructions to determine a payroll for a predetermined period of time, the code instructions associated with a client account. The storage medium may contain reconciled data associated with a plurality of commercial transactions, wherein the data is transmitted from a point-of-sale system, a client computer, and a financial record server, the data comprising a transaction date, a transaction amount, and a transaction identifier. The one or more processors may be electrically coupled to the transceiver and the storage medium, and programmed to: determine payroll information associated with the client account, retrieve the reconciled data from the storage medium, and transmit, to a client display device over the network, a report based on the reconciled data, the report is selected from a group consisting of a balance sheet, a tax report, a fee statement, a detailed statement of transactions, an accounting report, an income statement, and a cash flow statement.

As can be appreciated, the one or more processors may be further programmed to transmit, over the network, payment instructions to the financial record server based on the determined payroll information. The one or more processors may be further programmed to automatically transmit, over the network, the report to a second server to report tax or fee liability, and automatically receive, from the second server, a tax/fee statement based on the report. Further, as noted above, the report may be generated at a third party server, and the one or more processors may receive the generated report from the third party server, and store the generated report in the storage medium.

Non-transitory computer-readable mediums are also provided. In one embodiment, a non-transitory computer-readable mediums may provide instructions, which when read by a computer having a processor and a database, cause the computer to perform operations comprising: electronically receiving, over a network, one or more encoded data associated with a plurality of commercial transactions, wherein the encoded data is transmitted from a point-of-sale system, a client computer, and a financial record server, the encoded data comprising a transaction date, a transaction amount, and a transaction identifier; decoding the encoded data; reconciling the decoded data; automatically generating a report based on the encoded data, the report is selected from a group consisting of a balance sheet, a tax/fee report, a detailed statement of transactions, an accounting report, an income statement, and a cash flow statement; and automatically transmitting, over the network, the generated report to a government server to report tax/fee liability.

In one embodiment, the non-transitory computer readable medium may include instructions that cause the computer to receive, from the client computer, a request code to transmit an electronic invoice to a recipient email address, generate the electronic invoice based on the request code, and transmit the generated electronic invoice to the recipient email address. Further, the non-transitory computer readable medium may include instructions that cause the computer to automatically receive, from the government server, a tax statement from the government based on the generated report. In yet another embodiment, the non-transitory computer readable medium may include instructions that cause the computer to further perform operations comprising: receiving, from the client computer, code instructions to determine a payroll for a predetermined period of time, the code instructions associated with a client account; and in response to receiving the code instructions to determine a payroll, automatically generating payroll information associated with the client account; and transmit, over the network, the payroll information associated with the client account for display on a client display device.

In some embodiments, a system for data management is provided. In some embodiments, the system comprises a transceiver configured to receive, from a client computer over a network, code instructions to determine a payroll for a predetermined period of time, the code instructions associated with a client account; a storage medium comprising reconciled data associated with a plurality of commercial transactions, wherein the data is transmitted from a point-of-sale system, a client computer and a financial record server, the data comprising a transaction date, a transaction amount, and a transaction identifier; and one or more processors electrically coupled to the transceiver and the storage medium, the one or more processors programmed to generate payroll information associated with the client account, retrieve the data from the storage medium, and transmit a generated report based on the retrieved data and the payroll information, the report is selected from a group consisting of a balance sheet, a tax/fee report, a detailed statement of transactions, an accounting report, an income statement, a payroll statement, and a cash flow statement.

In some embodiments of the data management system, the one or more processors is/are further programmed to transmit, over the network, the payroll information associated with the client account to display on a client display device. The one or more processors may also be further programmed to transmit, over the network, payment instructions to the financial record server based on the generated payroll information. The one or more processors may also be further programmed to automatically transmit, over the network, the generated report to a second server to report tax/fee liability. In yet other embodiments, the one or more processors may be further programmed to automatically receive, from the second server, a tax/fee statement based on the generated report.

In some embodiments, the transceiver is further configured to receive, from the client computer, a request code to transmit an electronic invoice to a recipient email address, and wherein the one or more processors is further programmed to obtain a generated electronic invoice based on the request code, and to transmit the electronic invoice to the recipient email address. The system may also include means for generating the report based on the retrieved data and the payroll information.

In some embodiments, the one or more processors reconcile the data from the point-of-sale system, the client computer, and the financial record server, and stores the reconciled data on the storage medium.

In a further embodiment, a non-transitory computer-readable medium provides instructions, which when read by a computer having a processor accessing a database, may cause the computer to perform operations comprising: storing on a storage medium data associated with a plurality of commercial transactions, wherein the data is transmitted from a point-of-sale system and at least one of a client computer and a financial record server, the data comprising a transaction date, a transaction amount, and a transaction identifier; receiving, from the client computer over a network, code instructions to determine a payroll for a predetermined period of time, the code instructions associated with a client account; generate/obtain payroll information associated with the client account; retrieving the data from the storage medium; and generating a report based on the retrieved data, the report is selected from a group consisting of a balance sheet, a tax/fee report, a detailed statement of transactions, an accounting report, an income statement, and a cash flow statement.

The non-transitory computer readable medium may provide instructions, which when read by a computer having a processor accessing a database, may cause the computer to perform the following operations: transmitting, over the network, the payroll information associated with the client account for display on a client display device; and/or transmitting, over the network, payment instructions to the financial record server based on the generated payroll information; and/or transmitting, over the network, the generated report to a second server to report tax liability; and automatically receiving, from a second server, a tax statement based on the generated report. Also, the non-transitory computer readable medium may provide instructions, which when read by a computer having a processor and a database, may cause the computer to perform the following operations: receiving, from the client computer, a request code to transmit an electronic invoice to a recipient email address; upon receipt of the record request code, generating the electronic invoice; and transmitting the generated electronic invoice to the recipient email address.

In yet another embodiment, a non-transitory computer-readable medium provides instructions, which when read by a computer having a processor accessing a database, may cause the computer to perform operations comprising: storing reconciled data associated with a plurality of commercial transactions, wherein the data is transmitted from a point-of-sale system, a client computer and a financial record server, the data comprising a transaction date, a transaction amount, and a transaction identifier; receiving, from the client computer over a network, code instructions to determine a payroll for a predetermined period of time, the code instructions associated with a client account; determining payroll information associated with the client account; retrieving the data from the storage medium; and transmitting, to a client display device over the network, a report based on the retrieved data and the payroll information, the report is selected from a group consisting of a balance sheet, a tax/fee report, a detailed statement of transactions, an accounting report, an income statement, and a cash flow statement.

As noted above, the non-transitory computer readable medium may provide instructions, which when read by a computer having a processor accessing a database, may cause the computer to perform the following operations: transmitting, over the network, payment instructions to the financial record server based on the determined payroll information; and/or automatically transmit, over the network, the report to a second server to report tax liability; and/or automatically receiving, from a second server, a tax statement based on the report. Further, the non-transitory computer readable medium may provide instructions, which when read by a computer having a processor and a database, may cause the computer to perform the following operations: receiving, from the client computer, a request code to transmit an electronic invoice to a recipient email address; generating the electronic invoice based on the received request code; and transmitting the electronic invoice to the recipient email address, wherein the report is further based on the electronic invoice.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 illustrates a block diagram of a data management system, according to an embodiment of the present disclosure.

FIG. 2 illustrates an exemplary flowchart outlining the operation of a data management system for automatically generating a report based on data reconciled from a point-of-sale system and from a client computer, according to an embodiment of the present disclosure.

FIG. 3 illustrates an exemplary flowchart outlining the operation of a data management system for generating a report, via a third party server, based on reconciled data from a point-of-sale system and from a client computer, according to an embodiment of the present disclosure.

FIG. 4 illustrates an exemplary flowchart outlining the operation of the data management system of FIGS. 2 and/or 3, for receiving financial institution data and automatically generating a report based on the financial institution data and the data from the point-of-sale system and the client computer, according to an embodiment of the present disclosure.

FIG. 5 illustrates an exemplary flowchart outlining the operation of the data management system of FIGS. 2 and/or 3, for processing payroll associated with a client account, according to an embodiment of the present disclosure.

FIG. 6 illustrates an exemplary flowchart outlining the operation of a data management system for automatically transmitting to a government server a generated report based on encoded reconciled data from a point-of-sale system, a client computer and a financial record server, and automatically receiving a tax statement based on the generated report, according to an embodiment of the present disclosure.

FIG. 7 illustrates an exemplary flowchart outlining the operation of the data management system of FIG. 6, for generating and transmitting an electronic invoice, according to an embodiment of the present disclosure.

FIG. 8 illustrates an exemplary flowchart outlining the operation of a data management system of FIG. 6, for processing payroll associated with a client account, according to an embodiment of the present disclosure.

FIG. 9 illustrates an exemplary flowchart outlining the operation of a data management system for reconciling payroll information and data from at least one of a point-of-sale system, a client computer, and a financial record server, and generating a report based on the reconciled data, according to an embodiment of the present disclosure.

FIG. 10 illustrates an exemplary flowchart outlining the operation of a data management system of FIG. 9, for transmitting to a government server the generated report and automatically receiving a tax statement based on the generated report, according to an embodiment of the present disclosure.

FIG. 11 illustrates an exemplary flowchart outlining the operation of a data management system of FIG. 9, for generating an electronic invoice, according to an embodiment of the present disclosure.

FIG. 12 illustrates an exemplary flowchart outlining the operation of a data management system for processing payroll associated with a client account and transmitting a generated report based on payroll information and data from a point-of-sale system, a client computer, and a financial record server, according to an embodiment of the present disclosure.

FIG. 13 illustrates an exemplary user interface for managing income, processing electronic invoicing and collecting payment with payment gateway, according to an embodiment of the present disclosure.

FIG. 14 illustrates an exemplary user interface for managing expenses and displaying electronic invoices, according to an embodiment of the present disclosure.

### DETAILED DESCRIPTION

The following detailed description includes representative examples utilizing numerous features and teachings, both separately and in combination, and describes numerous embodiments that relate to systems, methods, and machine-readable mediums for processing digital or cryptographic transactions to collect account receivables using a digital wallet, automatically reconciling with financial data from multiple sources, and generating a report, such as a balance sheet, a tax/fee report, a detailed statement of transactions, an accounting report, an income statement, and a cash flow statement. This detailed description is merely intended to teach a person of skill in the art further details for practicing one or more embodiments of the present disclosure and is not intended to limit the scope of the claims. Therefore, combinations of features disclosed in the following detailed description and incorporated documents may not be necessary to practice the teachings in the broadest sense, and are instead taught merely to describe particularly representative examples of the present teachings.

Some portions of the detailed description that follow are presented in terms of algorithms and sequences of operations, which are performed within a computer memory. These algorithmic descriptions and representations are the means used by those skilled in the data processing arts to most effectively convey the substance of their work to others skilled in the art. An algorithm or sequence of operations is here, and generally, conceived to be a self-consistent sequence of steps leading to a desired result. The steps are those requiring physical manipulations of, for example, electric, optic, or magnetic signals capable of being processed, transmitted received, stored, combined, compared, and/or otherwise manipulated.

Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic device, that manipulates and transforms data represented as electronic quantities within the computer system's registers and memories into other data similarly represented as physical quantities within the electronic device's memory or registers or other such information storage, transmission or display devices.

Embodiments of the present disclosure include systems, methods and machine-readable mediums for managing and/or reconciling financial data of a business, entity or individual. In one embodiment, the systems, methods and machine-readable mediums comprise a computing platform, such as an Enterprise Resource Planning (ERP) software, to integrate one or more software applications for managing the business and automating back office functions related to technology, services, accounting, taxes, human resources and/or electronic financial advisory. The systems, methods and machine-readable mediums may be adapted to integrate and/or reconcile financial data from a point-of-sale system, a client computer, and/or a financial record server, and generate one or more reports, such as a balance sheet, a tax report, a detailed statement of transactions, an accounting report, an income statement, and a cash flow statement. The report(s) may then be submitted electronically to a government server to report tax liability. In one embodiment, the systems, methods and machine-readable mediums may be further adapted to integrate electronic invoicing, payroll processing, dynamic website generation and other business applications.

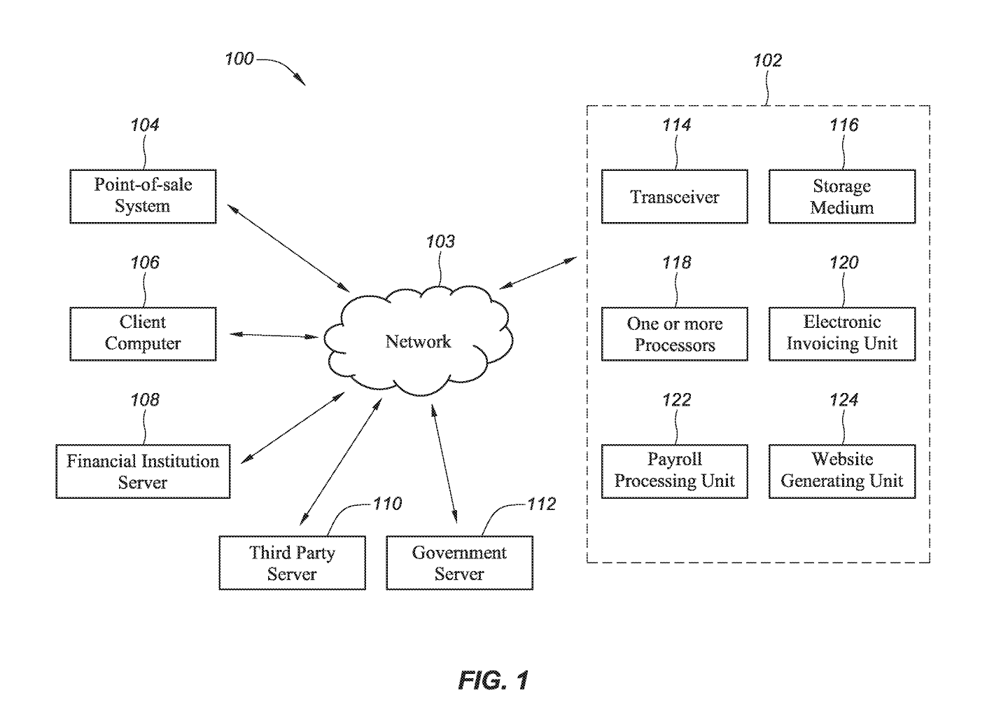

FIG. 1 illustrates a block diagram 100 of a data management system 102, according to an embodiment of the present disclosure. The data management system 102 may include a computing platform to collect account receivables (using, for example, a digital wallet), integrate financial data from one or more applications, reconcile the financial data, and optionally generate one or more reports, including those that may be submitted to a second server to report tax/fee liability. In one embodiment, the system 102 may generate and utilize a blockchain to maintain a distributed ledger of electronically processed financial transactions used in facilitating collection of account receivables. The system 102 may be configured to communicate with one or more computing platforms, according to client/server architecture, a peer-to-peer architecture, and/or other architectures. The users may access system 102 via the computing platform(s). The system 102 may be accessible, via a network 103, to a plurality of computing devices, such as a point-of-sale system 104, a client computer 106, a financial record server 108, a third party server 110 and/or a second server 112. In one embodiment, a computing device may be a computing node on the network 103.

In one embodiment, the point-of-sale system 104 may be programmed to transmit transaction data to and/or from the system 102. In another embodiment, the point-of-sale system 104 may be associated, coupled and/or integrated physically or electronically with system 102.

As can be appreciated, the point-of-sale system 104 may be a card or cardless processing unit, such as, but not limited to, cashier-operated checkout systems registers, cash registers, electronic cash registers, Square@ credit card readers, bile device payment and “digital wallet” services, such as Apple® Pay, Samsung@ Pay, Android Pay, Coinbase and the like), self-checkout systems, and other similar transaction and payment processing devices. In one embodiment, the structures and functions (including cryptographic techniques and distributed computing) of the point-of-sale system 104 may include, but not limited to, those disclosed in U.S. Publ. No. 20130159119, U.S. Publ. No. 20130279110, U.S. Publ. No. 20150206132, U.S. Publ. No. 20140012757, U.S. Publ. No. 20150235195, U.S. Publ. No. 20150081556, U.S. Pat. No. 8,678,277, U.S. Pat. No. 9,047,598, U.S. Pat. No. 8,840,024, U.S. Pat. No. 9,063,737, U.S. Pat. No. 8,500,018, U.S. Pat. No. 9,037,491, U.S. Pat. No. 8,573,487, U.S. Pat. No. 8,625,838, U.S. Pat. No. 7,591,430, U.S. Pat. No. 7,540,410, all of which are incorporated herein by reference in their entirety.

As can be appreciated, the apparatus and execution environment realize various different computing model infrastructures, such as web services,distributed computing and grid computing infrastructures. The computer program can be deployed to be executed on one computer or on multiple computers that are located at one site or distributed across multiple sites and interconnected by a communication network. The communications can be encrypted using secure protocols built into the user device, server system, and merchant device. In one embodiment, the database is used broadly to include any known or convenient means for storing data, whether centralized or distributed, relational or otherwise.

In other embodiments, the structures and functions (including cryptographic techniques and distributed computing) of the system 104 may include, but not limited to, those disclosed in U.S. Pat. No. 9,704,143, U.S. Pat. No. 8,523,657, U.S. Pat. No. 9,679,276, U.S. Pat. No. 9,686,247, U.S. Pat. No. 9,722,790, U.S. Pat. No. 9,600,817, U.S. Pat. No. 9,258,307, and Satoshi Nakamoto, Bitcoin: A peer-to-Peer Electronic Cash System, 2008, all of which are incorporated herein by reference in their entirety.

Artisans would appreciate that the point-of-sale system 104 may be programmed to process cryptographic/digital transactions to collect account receivables using a “digital wallet.” As can be appreciated, the “digital wallet” may be used to electronically store value or digital currency (e.g., cryptocurrency, such as Bitcoin, Ethereum and the like). A digital currency is a digital medium of exchange that enables distributed, rapid, cryptographically secure, confirmed transactions for goods and/or services. It may include specifications regarding the use of the currency that seek to incorporate principles of cryptography (e.g., public-key cryptography) to implement a distributed and decentralized information economy.

In one embodiment, the “digital wallet” may be stored on the client computer 106 and/or hosted on a third-party website. The “digital wallet” may display to users their available balance, any transaction history, and the collection of electronic addresses (i.e. public key addresses) that they may have or use to send and receive cryptocurrency with other users. In one embodiment, to transfer digitally stored value or cryptocurrency, an owner may digitally sign a hash of a previous transaction and a public key of the payee, and then adding these to the end of the cryptocurrency address. With such information viewable in the cryptocurrency address, the payee can verify, via the computing platform, the chain of ownership. For example, when a bitcoin belonging to user A is transferred to user B, user A's ownership over that bitcoin is relinquished by adding user B's public key address to the bitcoin, and signing the result with the private key that is associated with user A's address. User B now owns the bitcoin and can transfer it further. Meanwhile, in this example, user A is prevented from transferring the already spent bitcoin to other users because a public list of all previous transactions may be collectively maintained, in chronological order, on a peer-to-peer distributed time-stamped ledger, such as a blockchain.

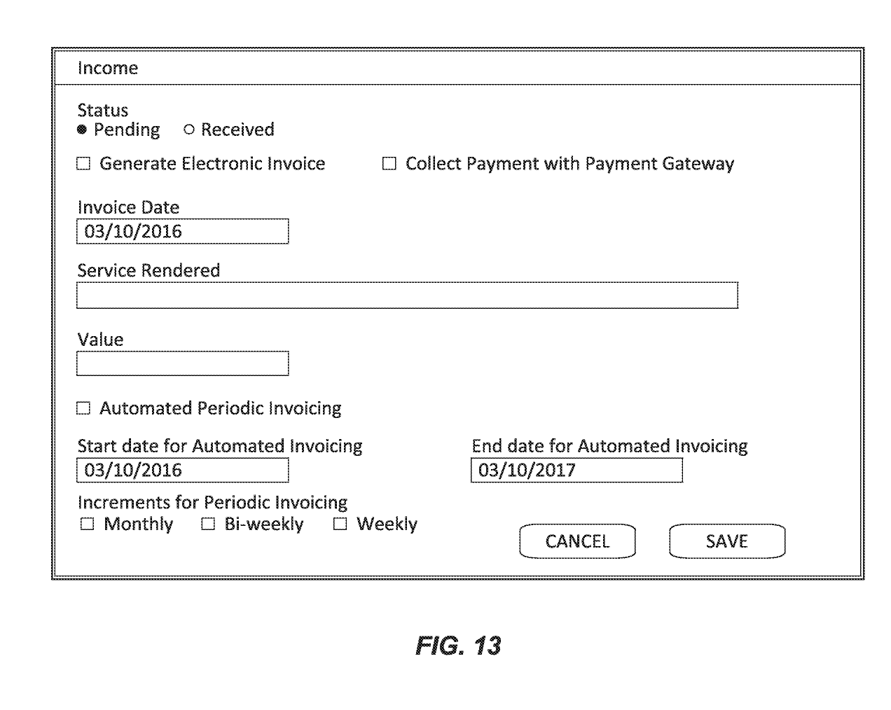

In another embodiment, the point-of-sale system 104 may be an online secured payment gateway, such as PayPal®, which may be integrated with the system 100 (as shown as an example in FIG. 13) to collect and/or process electronic payments of account receivables associated with a client account, and to transmit point-of-sale data of payments made to the system 102 for reconciliation with other data and for generating a report, such as a tax/fee report, as further detailed below.

Similarly, the financial record server 108 may be programmed to transmit financial institution data associated with a client account to the system 102. The financial institution data may include, but not limited to, bank statements, investment portfolio data (for example, for stocks, funds, bonds, etc.), loan statements, and the like. In one embodiment, the financial record server 108 may be programmed to transmit real-time financial institution data.

Further, the client computer 106 may be adapted to transmit data entries associated with one or more commercial transactions, for example, financial data inputted by the user to the system 102. Such inputted financial data may include payments made and/or received in connection with a client account.

The client computer 106, the financial record server 108, the third party server 110 and/or the second server 112 may run commercially-available Web browser applications such as Microsoft Internet Explorer®, which implements World Wide Web standards such as HTTP, HTML, XML, java, Flex, Ajax and the like. In one embodiment, the system 102 transmits the generated report to display on a webpage at the client computer 106, the third party server 110 and/or the second server 112.

In one embodiment, the system 102 may be used to manage a client's business cash flow by reconciling all business accounts. This may include accounts for payroll, suppliers, expenses, utilities, taxes, investments, office expenses, capital contributions, financial income and sales. In one embodiment, this information may then be used by third party tax software to produce client taxes information that may then be managed by the customer as electronic documents. In another embodiment, the software may also manage client and supplier information, electronic documents as well as tax information and electronic invoicing. As can be appreciated, the software may integrate with one or more application program interfaces (APIs), for example, to facilitate electronic communication with third party systems, such as point-of-sale systems for payment processing.

In one embodiment, the system 102 may include a transceiver 114, a storage medium 116, and one or more processors 118. The computing platform and/or website content may be distributed over several Internet domains, and may be implemented using several servers located at various locations. Of course, a variety of networks, both public and private, may be used as well. The system 102 may use a commercially available Internet server, which accesses the storage medium 116 that may be used to store and/or dynamically generate Web pages in response to end user actions.

As used herein, the term “storage medium” (also known as “computer readable storage medium” or “computer-readable medium”) is used broadly to include any known or convenient means for storing data, whether centralized or distributed, relational or otherwise. The Web pages may be in the form of HTML pages or the like. In one embodiment, the system 102 may be implemented as one or more functional modules. As used herein, the term module refers to logic embodied in hardware, firmware, and/or a collection of software instructions. The system 102 can also include, in addition to hardware, code that creates an execution environment for a computer program in question, e.g., code that constitutes processor firmware, a protocol stack, a database management system, an operating system, a cross-platform runtime environment, a virtual machine, or a combination of one or more of them. The system 102 and execution environment can realize various different computing model infrastructures, such as web services, distributed computing and grid computing infrastructures.

The computer readable storage medium may be, for example, but is not limited to, an electronic storage device, a magnetic storage device, an optical storage device, an electromagnetic storage device, a semiconductor storage device, or any other storage media.

Computer readable program instructions described herein can be transferred, inputted, or downloaded to respective computing/processing devices from a computer readable storage medium or to an external computer or external storage device via a network, for example, the Internet, a local area network, a wide area network and/or a wireless network. The computer readable program instructions (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer readable program instructions may, but need not, be deployed to be executed on one computer or on multiple computers that are located at one site or distributed across multiple sites and interconnected by a communication network.

The transceiver 114 may be configured to send and/or receive, over the network 103, one or more encoded and/or encrypted data associated with a plurality of commercial transactions, to/from the point-of-sale system 104, the client computer 106, the financial record server 108, the third party server 110 and/or the second server (i.e. government server) 112. In one embodiment, the data may comprise a transaction date, a transaction amount, and a transaction identifier, such as a merchant's name, contact information, and the good/service purchased or sold, among others. This data (in encoded or decoded form) may be stored in the storage medium 116. In one embodiment, the transceiver 114 may also be configured to receive, from the client computer 106, code instructions associated with a client account to determine a payroll for a predetermined period of time, and/or to perform electronic invoicing and/or to dynamically generate a website.

The one or more processors 118 may be electrically coupled to the transceiver 114 and the storage medium 116, and programmed to decode the encoded data (and/or decrypt the encrypted data) from the point-of-sale system 104, the client computer 106, and/or the financial record server 108, reconcile the decoded and/or decrypted data, and then generate a report based on the decoded and/or decrypted data. The report may include a balance sheet, a tax/fee report, a detailed statement of transactions, an accounting report, an income statement, a cash flow statement, a tax/fee statement, a payroll statement, and the like. In one embodiment, the one or more processors 118 may be programmed to reconcile data on revenues, expenses, payroll, invoices, point-of-sale data and bank statements, for example, by receiving such information inputted or imported via the client computer 106, which the one or more processors 118 may then convert into ledger entries under generally accepted accounting principles by, for example, using a conversion table and/or a standard chart of accounts. As can be appreciated, the ledger may comprise a plurality of ledger accounts, wherein at least one ledger account comprises a plurality of transaction data, the transaction data arranged in data fields comprising assets, liabilities, cash flow, account receivables, revenue and/or expenses of the ledger account.

As can be appreciated by a person skilled in the art, on a company's balance sheet, accounts receivable is the money owed to that company by third party entities. Account receivables may be classified as current assets (assuming that they are due within a particular period). To record as a ledger entry for a sale on account, one may debit a receivable and credit a revenue account. When the third party entity pays off its account, one may debit cash and credit the receivable in the ledger. In one embodiment, the ledger is updated and/or reconciled to reflect a payment made by debiting a cash account and crediting the account receivable account in the ledger. Artisans would appreciate that other accounting principles may be employed to update and/or reconcile the ledger account for payment of account receivables associated with the sale of goods or services.

In one embodiment, a method of creating a report is provided. The one or more processors 118 may be programmed to electronically receive, from the point-of-sale system 104, a first data associated with a first commercial transaction, the first data comprising a first transaction date, a first transaction amount, and a first transaction identifier; and electronically receive, from a client computer, a first request code to transmit an electronic invoice comprising a second data associated with a second commercial transaction, the second data comprising a second transaction date, a second transaction amount, and a second transaction identifier. In response to the receipt of the first request code, the one or more processors 118 may be programmed to transmit on a transmission medium, the electronic invoice comprising the second data associated with the second commercial transaction; assign a first ledger code to the first data based on the first transaction identifier and a second ledger code to the second data based on the second transaction identifier; and electronically generate the report associated with a client financial account, wherein the client financial account has been reconciled with the first transaction amount based on the first ledger code and the second transaction amount based on the second ledge code.

In one embodiment, The one or more processors 118 may be programmed to transmit an activation code to process payment of the second transaction amount via a payment gateway; and in response to a user activation of the activation code, process payment of the second transaction amount via the payment gateway.

In another embodiment, the one or more processors 118 may be programmed to reconcile data by summing/adding all expenses together received electronically, for example, point of sale data from point-of-sale system 104, payroll information associated with client account, and financial statements from financial record server 108. In yet another embodiment, the one or more processors 118 may be programmed to reconcile data by summing/adding all revenues together received electronically, for example, point of sale data from point-of-sale system 104, financial statements from financial record server 108, and cryptographic currency from digital wallet.

In another embodiment, the one or more processors 118 may automatically transmit, via the transceiver 114, the generated report to the second server 112 to report tax/fee liability. Optionally, the one or more processors 118 may be further programmed to automatically receive, from the second server 112, a tax/fee statement based on the report.

In one embodiment, the one or more processors 118 may be programmed to compile the data from the point-of-sale system 104, the client computer 106, and/or the financial record server 108, and store (in encoded or decoded form and/or encrypted or decrypted form) in the storage medium 116. If such data is not in an encoded form, the one or more processors 118 may be further programmed to encode and/or encrypt the compiled data and, optionally, transmit over the network 103, the encoded and/or encrypted compiled data to the third party server 110. The third party server 110 may decode and/or decrypt the compiled data, and automatically generate the report based on the compiled data. In one embodiment, the third party server 110 may manage ledger entries based on the decoded and/or decrypted compiled data, generate one or more reports and any other files, documents, or data based on the ledger entries, and may then transmit the reports and data to the one or more processors 118. Alternatively, in another embodiment, the one or more processors 118 may be programmed to generate the report based on the encoded compiled data.

In one embodiment, a distributed ledger (i.e., a blockchain) may be used to certify the existence, integrity, and/or ownership of cryptographic transactions related to the collection of account receivables using a digital wallet. Generally speaking, a blockchain is a transaction database shared by some or all computing nodes participating in system 100. A full copy of the blockchain may contain every transaction ever executed in an associated digital currency. In addition to transactions associated with digital currency, other information disclosed herein, such as payroll, invoices, revenues, assets, expenses, liabilities, and any data on the storage medium, may be contained in the blockchain.

The blockchain may be based on several blocks. A block may include a record that contains and confirms one or more waiting transactions. Periodically, a new block including transactions and/or other information may be appended to the blockchain. In some implementations, a given block in the blockchain may contain a hash of the previous block. This may have the effect of creating a chain of blocks from a genesis block (i.e., the first block in the blockchain) to a current block. The given block may be guaranteed to come chronologically after a previous block because the previous block's hash would otherwise not be known. The given block may be computationally impractical to modify once it is included in the blockchain because every block after it would also have to be regenerated.

Artisans would appreciate that the system 102 may generate a blockchain having a plurality of ledger accounts. The system 102 may be adapted to, using one or more processors, to receive, from a first computing device associated with a first ledger account, a first data entry on a first account receivable for an amount due from a third party account, generate an electronic invoice based on the first data entry, transmit the electronic invoice to a second computing device, the second computing device associated with the third party account. The system 102 may be adapted to, using the one or more processors, to receive, from the second computing device, a request code to transfer a first payment being equal to or less than the amount due, for example, with cryptographic currency using a digital wallet. The system 102 may also update the first ledger account to reflect the transfer of the first payment, and generate a first report reflecting the update to the first ledger account based on the transfer of the first payment. In one embodiment, the system 102 may be adapted to verify that the third party account owns the cryptographic currency prior to recording, in the ledger, the change in ownership from the third party account to the first ledger account.

As can be appreciated, the system 102 may integrate one or more software applications to manage a business' finances and automate back office functions related to human resources. As previously noted, the transceiver may be configured to receive, from the client computer 106, code instructions associated with a client account to determine a payroll for a predetermined period of time. In response to receiving the code instructions to determine payroll, the one or more processors 118 may obtain payroll information associated with the client account, and transmit over the network 103 the payroll information associated with the client account for display on a client display device.

The payroll information may be stored in the storage medium 116 and retrieved for report generation. In one embodiment, the report generated by the one or more processors 118 may be based on the payroll information as well as the compiled data from the point-of-sale system 104, the client computer 106 and/or the financial record server 108. As can be appreciated, the one or more processors 118 may reconcile the payroll information with the compiled data from the point-of-sale system 104, the client computer 106 and/or the financial record server 108.

In one embodiment, the code instructions, received from the client computer 106, may be processed by the one or more processors 118 and/or by a payroll processing unit 122. The payroll processing unit 122 may integrate hardware, firmware, and/or software to determine payroll associated with a client account and to automatically generate payroll information associated with the client account. The payroll processing unit 122 may retrieve from the storage medium 116 an employee data, such as salary, hourly rate, social security, among others, and utilize this employee data, including optionally user inputs in the computing platform, such as number of hours for a pay period that an employee has worked, to compute the payroll payment for the employee. In one embodiment, the payroll processing unit 122 may also allow the user to manage employee accounts and records, and to compute tax liability for the business and its employees. In one embodiment, the one or more processors 118 and/or by a payroll processing unit 122 may be further programmed to transmit, over the network 103, payment instructions to the financial record server 108 based on the generated payroll information. As can be appreciated, the payment processing unit 122 may be directly or indirectly electrically coupled to the system 102. For example, the payment processing unit 122 may reside on third party server 110 and accessed electronically via network 103. In one embodiment, the one or more processors 118 may be programmed to compute the payroll payment, and transmit this computed information to the payroll processing unit 122 to calculate social security due and any payroll deductions.

In another embodiment, the system 102 may be programmed to receive salary data (for one or more employees) from the client computer 106 and store the salary data on the storage medium 116. To facilitate payroll processing, the system 102 may be further programmed to prompt the client to input additional data for certain pay period, such as number of days employee was absent, overtime, and/or deduction of excessive benefits. As noted above, the system 102 may then use the salary data and additional inputted data for a certain pay period, to compute the payroll for that pay period and to generate payment receipts as well as a payroll report. Alternatively, the data may be transmitted to the third party server 110 to calculate the payroll and generate payment receipts as well as a payroll report based on the payment receipts. As can be appreciated, the payment receipt may include information required by law such as social security tax withholding, etc.

In one embodiment, the system 102 or the third party server 110 may be programmed to also generate a payroll electronic file (in a government approved format), which may be transmitted electronically to the second server 112. As can be appreciated, the payment receipt and payroll file may be accessed on the client computer 110, via the computing platform. The client may then pay the employee based on the generated payment receipt.

In addition to payroll processing, and as previously noted, the system 102 may be further adapted for electronic invoicing. In one embodiment, the transceiver 114 may be further configured to receive, from the client computer 106, a request code to transmit an electronic invoice to a recipient email address. The request code can be any code including binary, integer, ASCII or the like that is pre-programmed with instructions to perform a specific operation, for example, (a) prompt queries relating to the invoice to identify or select customer information, services rendered/products sold, transaction amount and/or payment due date, (b) generate an electronic invoice the transaction based on the information provided in response to the queries, and (c) electronically transmit the invoice for payment. In response to the received request code, the one or more processors 118 may be programmed to generate the electronic invoice based on the request code, and to transmit the generated electronic invoice to the recipient email address. Alternatively, in another embodiment, in response to the received request code, the one or more processors 118 may be programmed to activate the third party server 110 to transmit a second request code to the second server 112 to transmit the electronic invoice to the recipient email address. As can be appreciated, in response to the received request code to transmit an electronic invoice, the one or more processors 118 may be further programmed to create an account receivable entry in the business' ledger, and is displayed via the computing platform. In one embodiment, the system 102 may record the amount due on the blockchain as an account receivable associated with a first ledger account and as an account payable associated with a second ledger account.

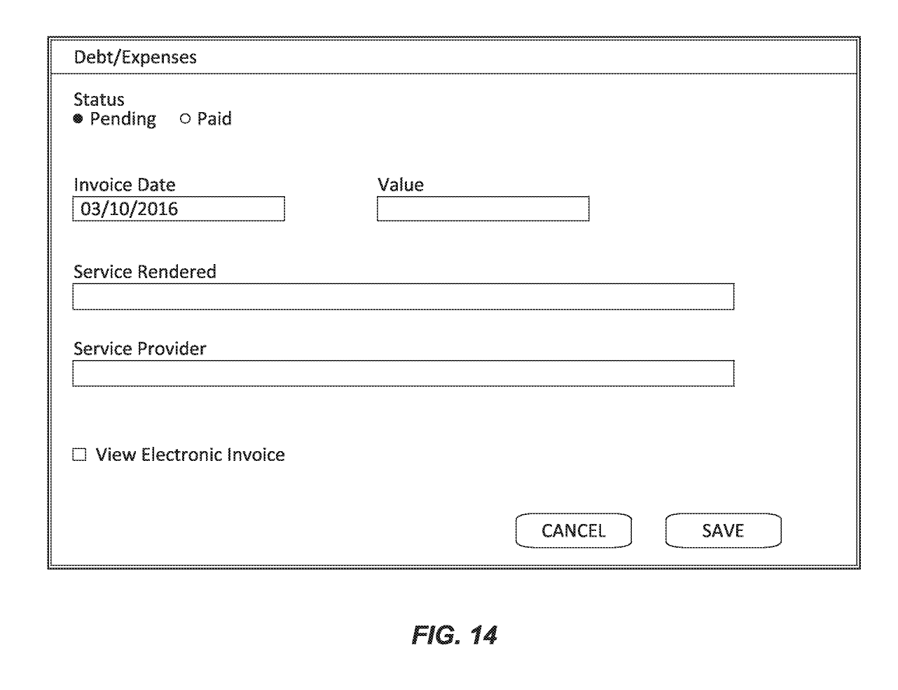

In one embodiment, the request code to transmit an electronic invoice may be processed by the one or more processors 118 and/or by an electronic invoicing unit 120. The electronic invoicing unit 120 may integrate hardware, firmware, and/or software to process the request code, generate an electronic invoice, and transmit such invoice to the identified recipient via email or other electronic means. In one embodiment, the electronic invoice may be accessed and/or displayed via recipient's computing platform on system 102, as shown in FIG. 14.

As can be appreciated, the generated electronic invoices and related payment records may be stored in the storage medium 116 and retrieved for report generation. In one embodiment, the report generated by the one or more processors 118 may be based on the generated electronic invoices as well as the compiled data from the point-of-sale system 104, client computer 106 and/or financial record server 108, and optionally, in combination, with the generated payroll information. For example, the one or more processors 118 may be programmed to reconcile the electronic invoice data with the compiled data from the point-of-sale system 104, client computer 106 and/or financial record server 108, and optionally, in combination, with the generated payroll information.

As can be appreciated, the system 102 integrates one or more applications to manage a business's finances and automate back office functions. By way of example, one integrated application may be a website generating unit 124 that generates a website associated with the client account in response to one or more client selections. For example, the computing platform may present to a user at a client computer 106, one or more options to select from, and upon receipt of such user selections, the website generating unit 124 dynamically generates one or more webpages associated with the client account. In one embodiment, the generated client webpages facilitate online sale of products or services, including facilitating online payment processing. As can be appreciated, the online payment processing for client webpages may be integrated electronically with the computing platform, whereby online processing data resulting from a transaction on a client webpage is automatically transmitted to the transceiver 114, via the network 103, and processed by the one or more processors 118. As can be appreciated, the system 102 may include a payment gateway (i.e. such as point of sale system 104) to facilitate online payment processing for transactions on a client webpage. The payment gateway may be associated or coupled with the electronic invoicing unit 120 to request the generating and transmission of an electronic invoice.

In one embodiment, the report generated by the one or more processors 118 may be based on the client online processing data in combination with the compiled data from the point-of-sale system 104, client computer 106 and/or financial record server 108, and optionally, in combination, with the electronic invoicing data and payroll information data.

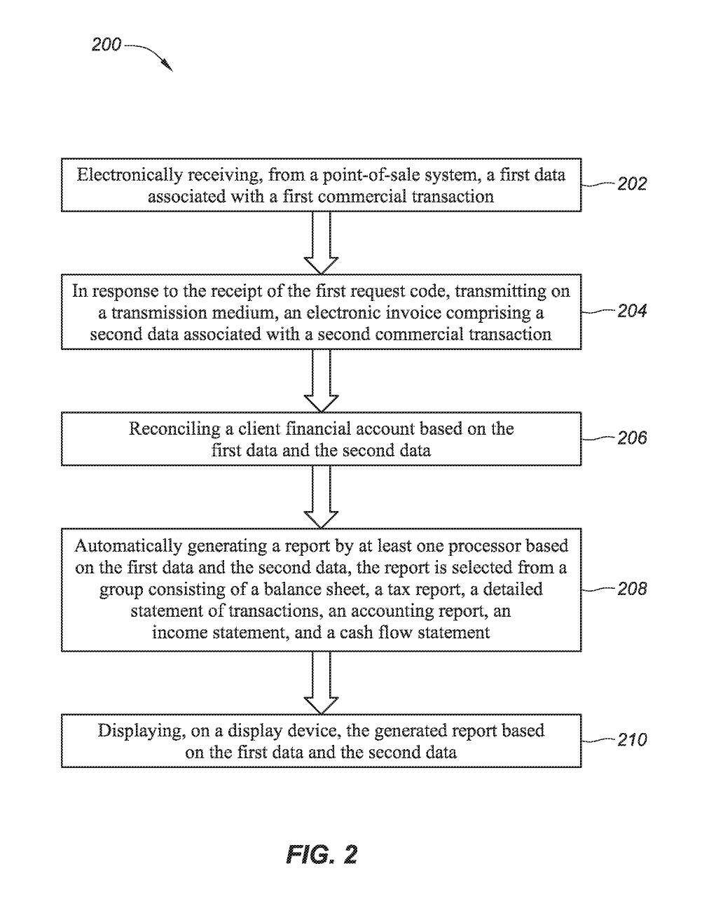

FIG. 2 illustrates an exemplary flowchart 200 outlining the operation of a data management system for automatically generating a report based on data reconciled from a point-of-sale system and from a client computer, according to an embodiment of the present disclosure. The method of operation may include electronically receiving, from a computing node such as point-of-sale system, a first data associated with a first commercial transaction (202), and in response to the receipt of a first request code, transmitting on a transmission medium, an electronic invoice comprising a second data associated with a second commercial transaction (204). The data management system may reconcile the first data and second data (206), and automatically generate a report by at least one processor based on the first data and the second data (206). As can be appreciated, the report may be a financial report, a balance sheet, a tax/fee statement, a payroll statement, a detailed statement of transactions, an accounting report, an income statement, a cash flow statement, and the like. In one embodiment, the data management system may also display, on a display device, the generated report based on the first data and the second data (210). As can be appreciated, the data and the generated reports, in this exemplary embodiment and those described below, may be contained in the blockchain.

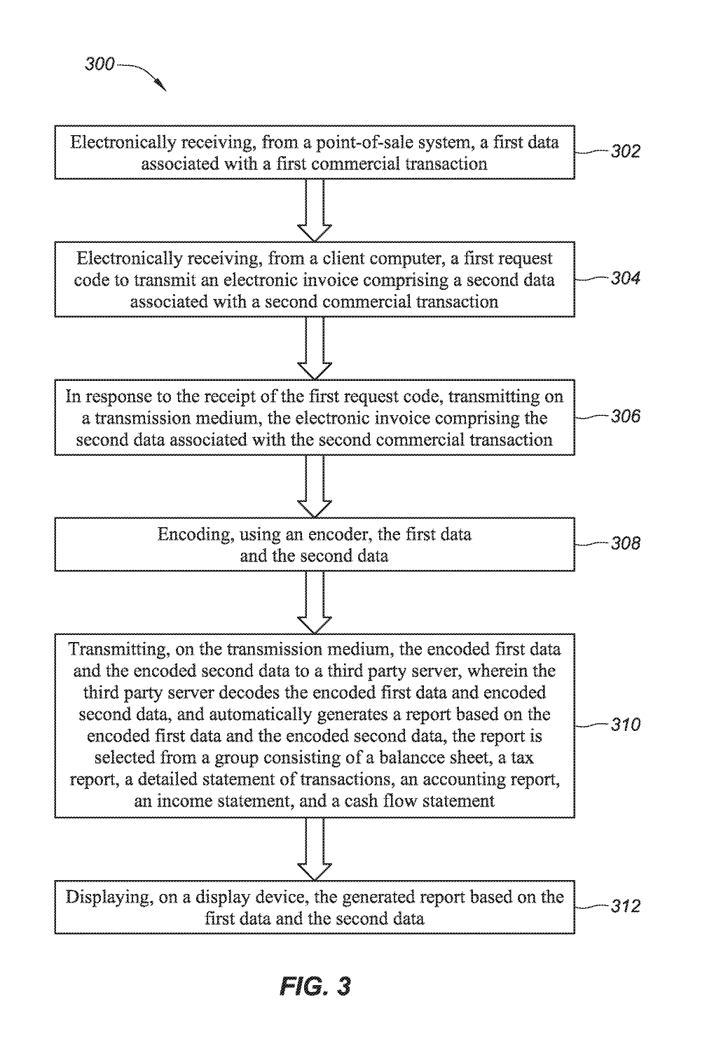

FIG. 3 illustrates an exemplary flowchart 300 outlining the operation of a data management system for generating a report, via a third party server, based on reconciled data from a point-of-sale system and from a client computer, according to an embodiment of the present disclosure. The method of operation may include electronically receiving, from a point-of-sale system, a first data associated with a first commercial transaction (302), and electronically receiving, from a client computer, a first request code to transmit an electronic invoice comprising a second data associated with a second commercial transaction (304). In response to the receipt of the first request code, the data management system may then transmit on a transmission medium, the electronic invoice comprising the second data associated with the second commercial transaction (306). Next, the data management system may encode, using an encoder (and/or one or more processors), the first data and the second data (308), and optionally transmit, on the transmission medium, the encoded first data and the encoded second data to a third party server 110 (310). In one embodiment, the encoded first data and encoded second data are transmitted individually. Alternatively, the first data and second data are reconciled, collectively encoded, and then transmitted to the third party server 110. In one embodiment, the third party server 110 decodes the encoded first data and encoded second data, and automatically generates a report based on the encoded first data and the encoded second data. As noted above, the report may be a balance sheet, a tax/fee report, a detailed statement of transactions, an accounting report, an income statement, a cash flow statement, and the like. In one embodiment, the data management system also displays, on a display device, the generated report based on the first data and the second data (312).

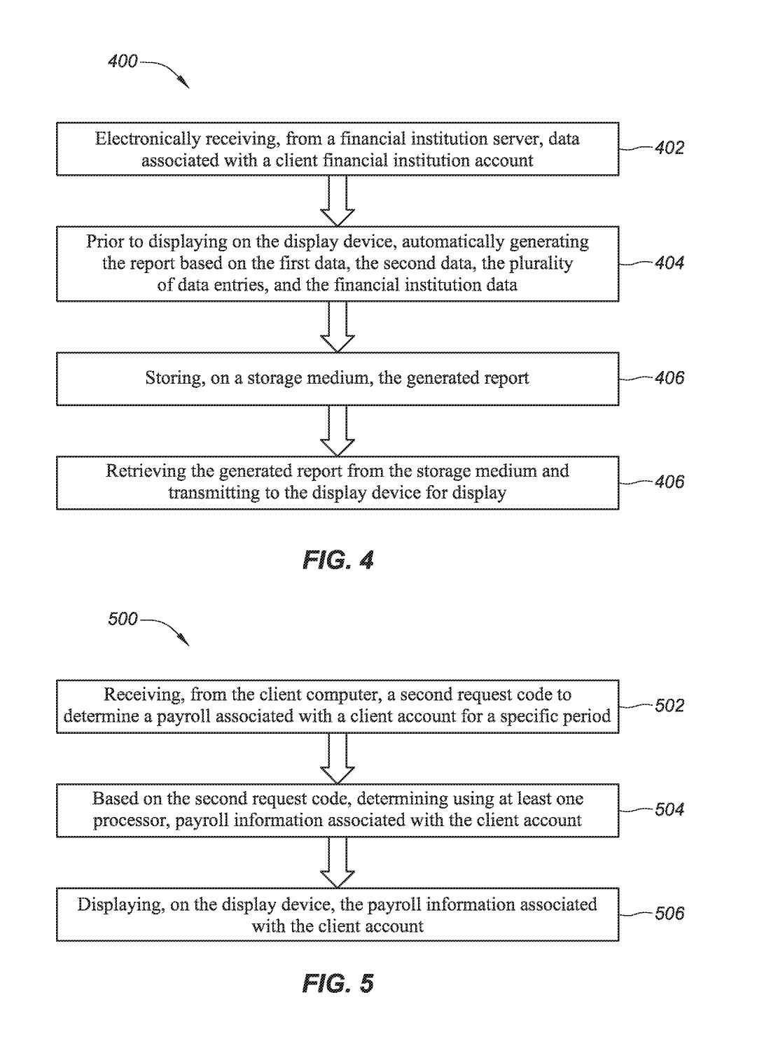

FIG. 4 illustrates an exemplary flowchart 400 outlining the operation of the data management system of FIGS. 2 and/or 3, for receiving financial institution data and automatically generating a report based on the financial institution data and the data from the point-of-sale system and the client computer, according to an embodiment of the present disclosure. The method of operation may further include electronically receiving, from a financial record server, financial institution data associated with a client financial account (402), and prior to displaying on the display device, automatically generating the report based on the first data, the second data, the plurality of data entries from the client computer 106, and the financial institution data (404). In one embodiment, the data management system may also store, on a storage medium, the generated report (406) and retrieve the generated report from the storage medium and transmitting to the display device for display (408).

FIG. 5 illustrates an exemplary flowchart 500 outlining the operation of the data management system of FIGS. 2 and/or 3, for processing payroll associated with a client account, according to an embodiment of the present disclosure. The method of operation may further include receiving, from the client computer 106, a second request code to determine a payroll associated with a client account for a specific period (502), and based on the second request code, determining using at least one processor, payroll information associated with the client account (504). The data management system may then display, on the display device, the payroll information associated with the client account (506).

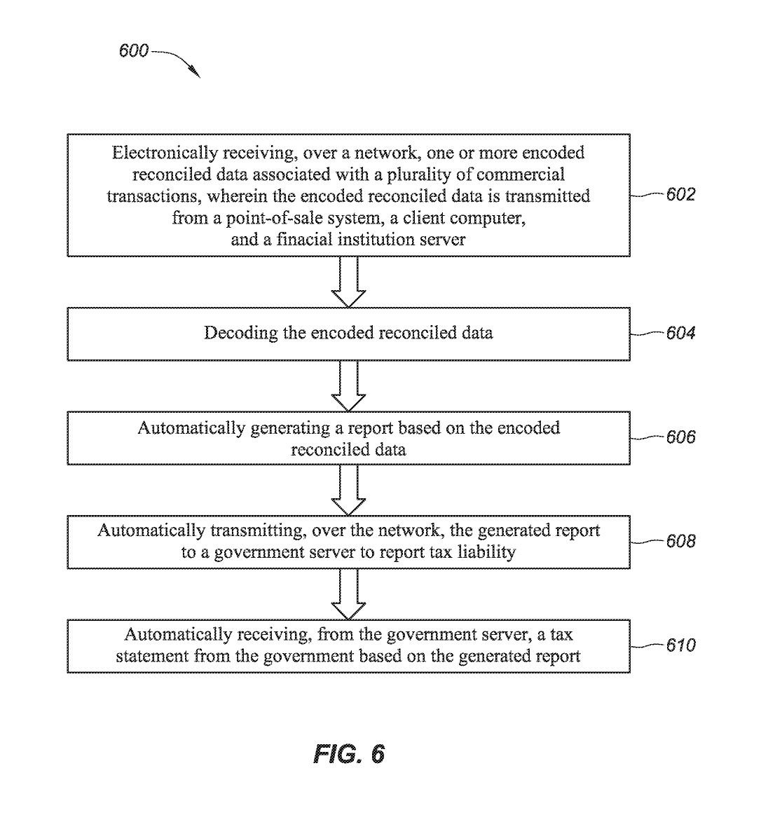

FIG. 6 illustrates an exemplary flowchart 600 outlining the operation of a data management system for automatically transmitting to a second server (i.e. government server) 112 a generated report based on encoded reconciled data from a point-of-sale system 104, a client computer 106 and a financial record server 108, and automatically receiving a tax/fee statement based on the generated report, according to an embodiment of the present disclosure. The method of operation may include electronically receiving, over a network, one or more encoded reconciled data associated with a plurality of commercial transactions, wherein the encoded reconciled data is transmitted from a point-of-sale system 104, a client computer 106, and a financial record server 108 (602), decoding the encoded reconciled data (604), and automatically generating a report based on the encoded reconciled data (606). As noted above, the report may be a balance sheet, a tax report, a detailed statement of transactions, an accounting report, an income statement, a cash flow statement, and the like. In one embodiment, the data management system may automatically transmit, over the network 103, the generated report to the second server 112 to report tax/fee liability (608). In another embodiment, the data management system may also automatically receive, from the second server 112, a tax statement based on the generated report (610).

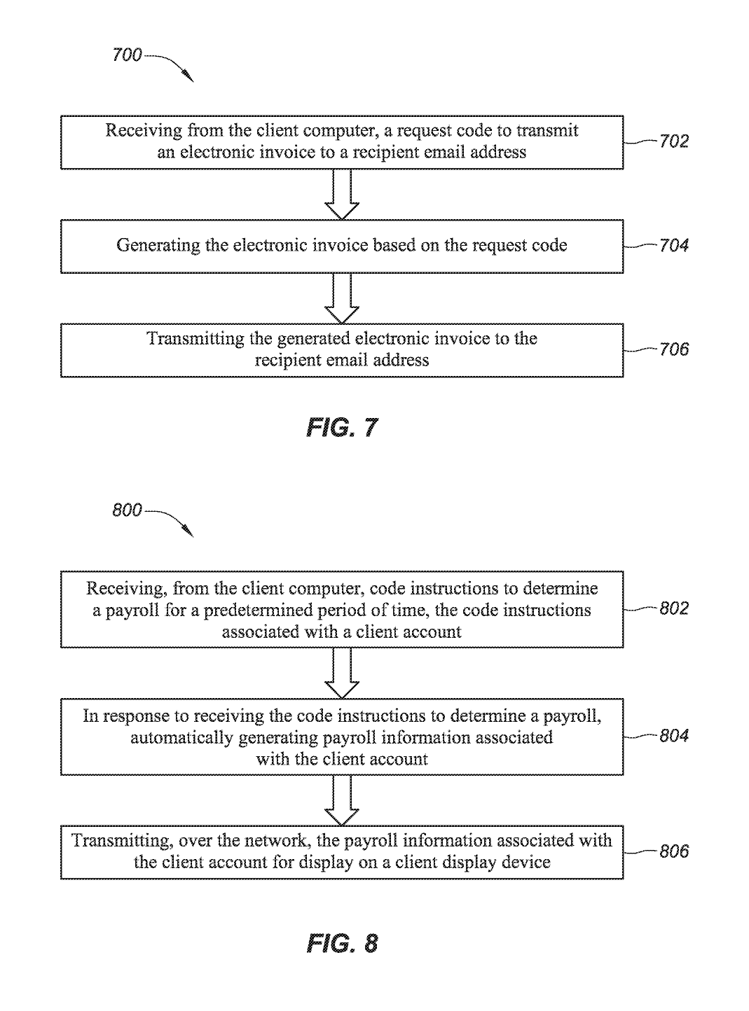

FIG. 7 illustrates an exemplary flowchart 700 outlining the operation of the data management system of FIG. 6, for generating and transmitting an electronic invoice, according to an embodiment of the present disclosure. The method of operation may further include receiving from the client computer 106, a request code to transmit an electronic invoice to a recipient email address (702), generating the electronic invoice based on the request code (704), and transmitting the generated electronic invoice to the recipient email address (706).

FIG. 8 illustrates an exemplary flowchart 800 outlining the operation of a data management system of FIG. 6, for processing payroll associated with a client account, according to an embodiment of the present disclosure. The method of operation may further include receiving, from the client computer 106, code instructions (associated with a client account) to determine a payroll for a predetermined period of time (802), in response to receiving the code instructions to determine a payroll, automatically generating and/or obtaining payroll information associated with the client account (804), and transmitting, over the network 103, the payroll information associated with the client account for display on a client display device (806).

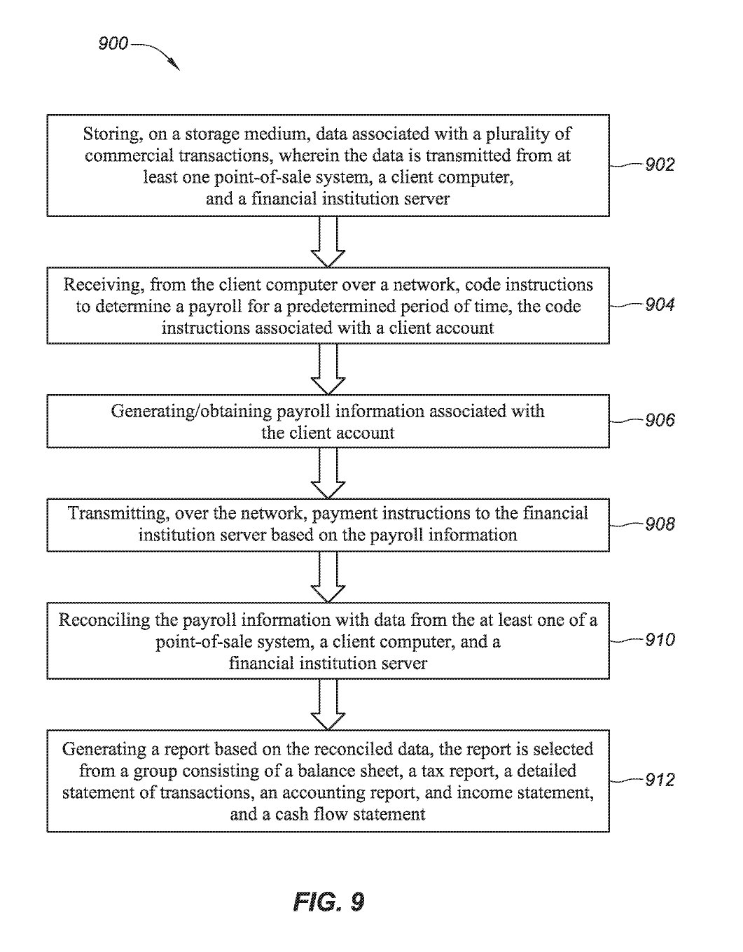

FIG. 9 illustrates an exemplary flowchart 900 outlining the operation of a data management system for reconciling payroll information and data from at least one of a point-of-sale system 104, a client computer 106, and a financial record server 108, and for generating a report based on the reconciled data, according to an embodiment of the present disclosure. The method of operation may include storing, on a storage medium, data associated with a plurality of commercial transactions, wherein the data is transmitted from at least one of a point-of-sale system 104, a client computer 106, and a financial record server 108 (902), receiving, from a client computer over a network, code instructions (associated with a client account) to determine a payroll for a predetermined period of time (904), and generating/obtaining payroll information associated with the client account (906). The data management system may then transmit, over the network, payment instructions to the financial record server 108 based on the payroll information (908). In one embodiment, the data management system may reconcile the payroll information with data from the at least one of a point-of-sale system 104, a client computer 106, and a financial record server 108 (910) and generate a report based on the reconciled data (912). The report may be a balance sheet, a tax/fee report, a detailed statement of transactions, an accounting report, an income statement, a cash flow statement, and the like.

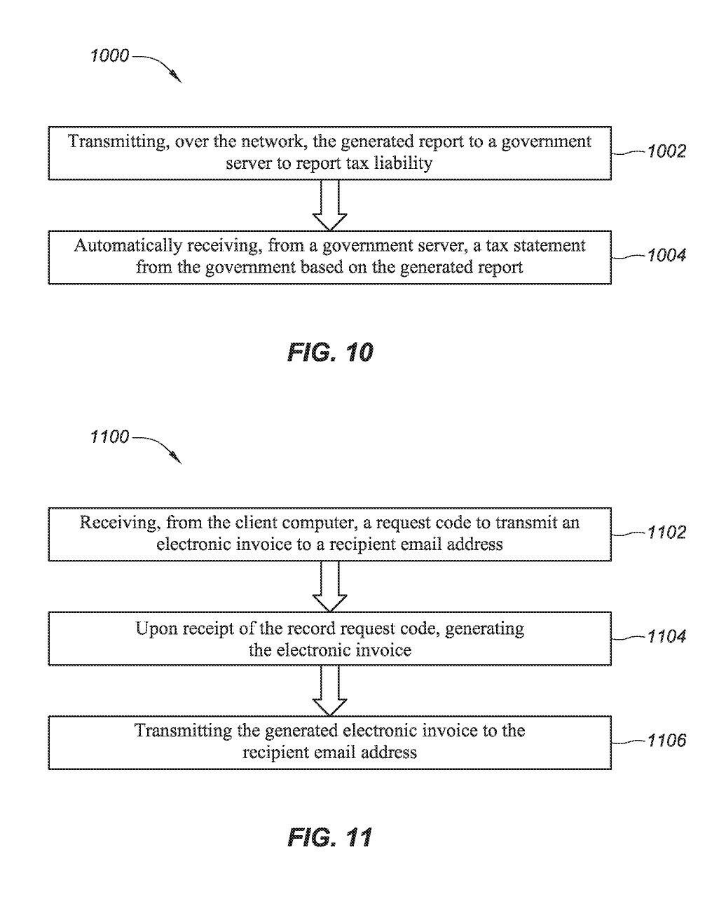

FIG. 10 illustrates an exemplary flowchart 1000 outlining the operation of a data management system of FIG. 9, for transmitting to a second server 112 the generated report and automatically receiving a tax/fee statement based on the generated report, according to an embodiment of the present disclosure. The method of operation may further include transmitting, over the network 103, the generated report to a second server 112 to report tax/fee liability (1002), and optionally, automatically receiving, from a second server 112, a tax/fee statement based on the generated report (1004).

FIG. 11 illustrates an exemplary flowchart 1100 outlining the operation of a data management system of FIG. 9, for generating an electronic invoice, according to an embodiment of the present disclosure. The method of operation may further include receiving, from the client computer 106, a request code to transmit an electronic invoice to a recipient email address (1102), and upon receipt of the record request code, generating the electronic invoice (1104). The data management system may then transmit the generated electronic invoice to the recipient email address (1106).

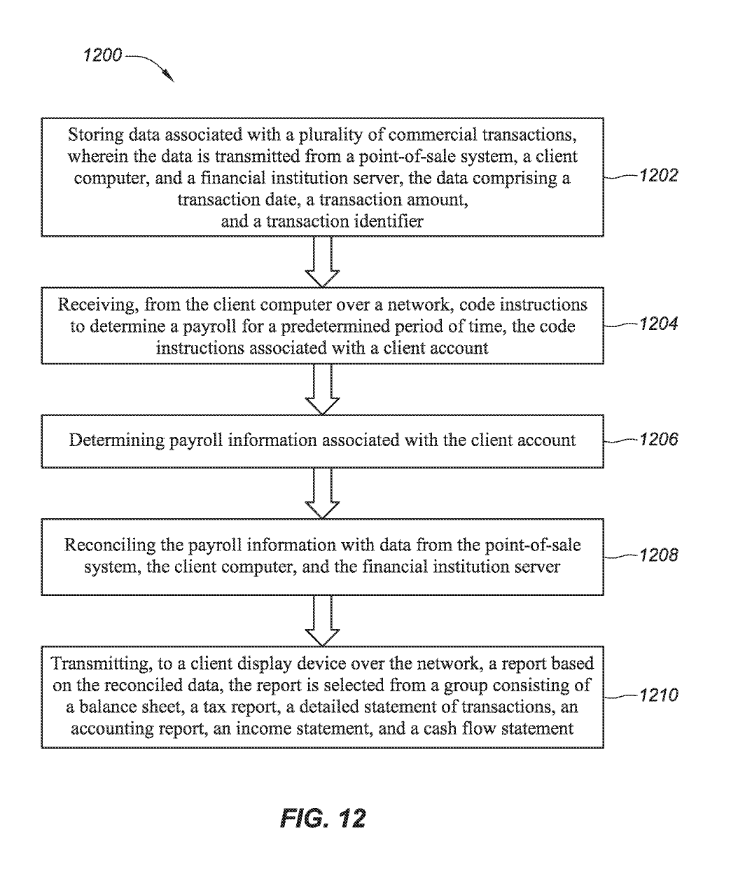

FIG. 12 illustrates an exemplary flowchart 1200 outlining the operation of a data management system for processing payroll associated with a client account and transmitting a generated report based on payroll information and data from a point-of-sale system, a client computer, and a financial record server, according to an embodiment of the present disclosure. The method of operation may include storing data associated with a plurality of commercial transactions, wherein the data is transmitted from a point-of-sale system 104, a client computer 106, and a financial record server 108, the data comprising a transaction date, a transaction amount, and a transaction identifier (1202), receiving, from a client computer 106 over a network 103, code instructions (associated with a client account) to determine a payroll for a predetermined period of time (1204), and determining payroll information associated with the client account (1206). The data management system may then reconcile the payroll information with data from the point-of-sale system 104, the client computer 106, and the financial record server 108 (1208), and transmit, to a client display device over the network 103, a report based on the reconciled data (1210). The report may be a balance sheet, a tax report, a detailed statement of transactions, an accounting report, an income statement, a cash flow statement, and the like.

FIG. 13 illustrates an exemplary user interface for managing income, processing electronic invoicing and/or collecting payment with payment gateway, according to an embodiment of the present disclosure. As shown in the exemplary FIG. 13, a client may input, via client computer 106, financial data of income received or accounts receivable (i.e. pending). If the client selects the “Pending” field to input financial data for account receivables, the client may then be prompted to select a box to “Generate Electronic Invoice” and/or to “Collect Payment with Payment Gateway.” As explained in an example above, the selection of “Generate Electronic Invoice” may then transmit a request code to one or more processors to generate the electronic invoice based on the request code, and to transmit the generated electronic invoice to the recipient email address. Further, the selection of “Collect Payment with Payment Gateway” may then trigger the point-of-sale system 104 to securely receive and process payment via debit card, credit card, digital wallet or other online payment methods, as previously discussed, for example, by processing cryptographic transactions to collect account receivables using a digital wallet. The payment may then be transferred to a financial account associated with the client, for example, in a digital wallet and/or at the financial institution 108. As can be appreciated, records of payments processed via the payment gateway, i.e., the point-of-sale system 104, may then be automatically reconciled with other financial data as described above, and may be displayed in the business' ledger via the computing platform.

In one embodiment, the user may be prompted to select automated periodic invoicing, identifying the particular start and end dates for the automated invoicing and the increments for the periodic invoicing. Artisans would further appreciate that the payment gateway may further be programmed to process payments associated with the automated periodic invoices. For example, along with a monthly electronic invoice is a link to the recipient to pay the invoice via the payment gateway. In one embodiment, a recipient may be able to also view the electronic invoice via a user interface as shown in FIG. 14. The financial data may be automatically identified and/or populated as a debt/expense for the recipient. Alternatively, the user may manually input the data via the client computer 106. As can be appreciated, financial data of income and debt/expenses may then be converted to ledger entries for reconciliation and for generation of accounting and tax reports, among others.

As can be appreciated, the present disclosure may be utilized with different computing platforms. In an exemplary embodiment, the computing platform may be a bookkeeping and/or accounting software that utilizes disruptive smart contract blockchain technology to facilitate collection of account receivables. The software may provide a distributed ledger for a peer-to-peer autonomous network to keep track of all financial transactions. Account receivable entries in the software initiate electronic collection protocols to automatically collect payment, in the form of tokens, fiat currency or cryptocurrency, while providing a quick, secure date and time stamped transaction. Once payment is received, the software automatically updates a user's account consistent with standard chart of accounts. Thus, in this example, reducing a business' time and expense in collecting accounts receivables and, because all transactions are based on cryptographic proof and are recorded on a distributed encrypted ledger, potentially obviating the need for obtaining an audit.

While the data management systems, methods, and machine readable mediums have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

As can be appreciated, the data management systems may further include encryption logic for encrypting cryptographic transactions recorded on the blockchain. In an example embodiment, encryption logic might include software, firmware, hardware, or any combination thereof, and consist of one or more encryption algorithms, e.g., an RSA encryption algorithm. Encryption logic may be used to encrypt the data with a public key to provide encrypted data. As noted in a prior example, the public key may be paired with an associated private key as is conventional when generating such keys using an RSA encryption algorithm, or other encryption algorithm known to those of ordinary skill in the art. The encrypted data can then only be accessed with the private key of the user, which may be stored in a more secure part on the client computer or other device.

Artisans would also appreciate that the data management systems, methods and machine-readable medium may include hashing logic. The hashing logic may be used for hashing certain data (e.g., personal information or transaction data or payroll) using a hashing algorithm to provide or generate a hash value. The hash value is sometimes referred to as “hash data,” that is generated by an algorithm. In an example embodiment, hashing logic might be software, firmware, hardware, or any combination thereof, and consist of one or more hashing algorithms, e.g., a Secure Hash Algorithm (SHA) algorithm. Hashing logic may pass the hash value to a digital-signature logic, which can be used to perform a digital signature on the hash value, using the private key on the input device. Artisans would appreciate that digital-signature logic may be implemented as a component (or module) of encryption logic or defined by separate code, firmware, and/or hardware.

In one embodiment, the digital-signature logic then passes the signed hash value and the public key to the computing platform. In an example embodiment, the computing platform may be part of an application or app that includes encryption logic, hashing logic, and digital-signature logic, and/or other modules or code.

As indicated above, in an exemplary embodiment, the data might be hashed and the resulting hash value might be signed with a digital signature, created using a private key paired with a public key, before transmission, optionally along with the public key, from the input device to the storage medium. The computing platform is thus adapted to “seal” the signed hash value and the public key. In one embodiment, once the hash value, and optionally the public key of the user is written to the blockchain in a transaction, proofs associated with the data may be utilized to allow for independent verification and certification. As can be appreciated, proofs may include a name of the data unit certified, a date and/or time of certification, a notary signee name and/or email address from a person and/or entity associated with certifying the data unit, hashing method information (e.g., a hashing algorithm), information related to a position of the data in a Merkle tree (e.g., a Merkle index, Merkle root information, etc.), a transaction identification, a version number, a web certification certificate, a PDF certification certificate, a JSON proof, a URL certified data unit sharing address, signatures related to cryptographic identities, and/or other information.

It should also be understood that a variety of changes may be made without departing from the essence of the invention. Such changes are also implicitly included in the description. They still fall within the scope of the invention. It should be understood that this disclosure is intended to yield a patent or patents covering numerous aspects of the invention both independently and as an overall system and in both method and apparatus modes.

Further, each of the various elements of the invention and claims may also be achieved in a variety of manners. This disclosure should be understood to encompass each such variation of an embodiment of any apparatus embodiment, a method, machine-readable medium or process embodiment, or even merely a variation of any element of these.

Particularly, it should be understood that as the disclosure relates to elements of the invention, the words for each element may be expressed by equivalent apparatus terms of method terms—even if only the function or result is the same. Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action. Similarly, each physical element disclosed should be understood to encompass a disclosure of the action which that physical element facilitates.

Any patents, publications, or other references mentioned in this application for patent are hereby incorporated by reference and are to be considered a part of the specification. In addition, as to each term used, it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans, incorporated herein by reference.

Finally, all references listed in the Information Disclosure Statement of other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant.

Further, all claim terms should be interpreted in their most expansive forms so as to afford the applicant the broadest coverage legally permissible. Although the embodiments have been described with reference to the drawings and specific examples, it will readily be appreciated by those skilled in the art that many modifications and adaptations of the processes and apparatuses described herein are possible without departure from the spirit and scope of the embodiments as claimed herein. Thus, it is to be clearly understood that this description is made only by way of example and not as a limitation on the scope of the embodiments as claimed below.

What is claimed is:

1. A system configured to process transactions on a ledger to facilitate collection of account receivables, the system comprising:
at least one storage medium storing machine readable instructions; and
one or more processors configured to execute the machine readable instructions to:
generate a ledger having a plurality of ledger accounts, wherein at least one ledger account comprises a plurality of transaction data, the transaction data arranged in data fields comprising assets, liabilities, cash flow, account receivables, revenue and expenses of the ledger account,
receive, from a first computing device associated with a first ledger account, a first data entry on a first account receivable for an amount due from a third party account,
generate an electronic invoice based on the first data entry;
transmit the electronic invoice to a second computing device, the second computing device associated with the third party account,
receive, from the second computing device, a request code to transfer a first payment, the first payment being equal to or less than the amount due,
update the first ledger account to reflect the transfer of the first payment, and
generate a first report reflecting the update to the first ledger account based on the transfer of the first payment, the first report is selected from a group consisting of a balance sheet, a tax report, a detailed statement of transactions, an accounting report, an income statement, and a cash flow statement.

2. The system of claim 1, wherein the one or more processors is further programmed to:
generate payroll information for a predetermined period of time, the payroll information associated with the first ledger account, and
transmit, over the network, the payroll information associated with the first ledger account for display on a client display device.

3. The system of claim 1, wherein the ledger is distributed to a plurality of computing nodes in a network, the computing nodes recording a change in ownership of the first payment from the third party account to the first ledger account upon receipt of the request code.

4. The system of claim 3, wherein the first computing device is one of the plurality of computing nodes.

5. The system of claim 1, wherein the one or more processors is further programmed to hash the transaction data using a hashing algorithm prior to recording in the ledger.

6. The system of claim 1, wherein the transaction data comprises a transaction date, a transaction amount, and a transaction identifier.

7. The system of claim 3, wherein the one or more processors is further programmed to verify that the third party account owns a cryptographic currency prior to recording, in the ledger, the change in ownership from the third party account to the first ledger account.

8. A non-transitory computer-readable medium that provides instructions, which when read by a computer having a processor and a database, cause the computer to perform operations comprising:
generating an encrypted ledger having a plurality of ledger accounts, wherein at least one ledger account comprises a plurality of transaction data, the transaction data arranged in data fields comprising assets, liabilities, account receivables, revenue and expenses of the ledger account;
receiving, from a first computing device associated with a first ledger account, a first data entry on a first account receivable for an amount due from a third party account;
generating an electronic invoice based on the transaction data;
transmitting the electronic invoice to a second computing device, the second computing device associated with the third party account;
receiving, from the second computing device, a request code to transfer a first payment;
hashing the transaction data using a hashing algorithm; and
updating the first ledger account to reflect the transfer of the first payment.

9. The non-transitory computer-readable medium of claim 8, wherein the instructions cause the computer to further perform operations comprising: recording a change in ownership of the first payment from the third party account to the first ledger account upon receipt of the request code.

10. The non-transitory computer-readable medium of claim 8, wherein the instructions cause the computer to further perform operations comprising: generating a first report for the first ledger account, the first report based on a change of ownership of the first payment from the third party account to the first ledger account upon receipt of the request code.

11. The non-transitory computer readable medium of claim 8, wherein the encrypted ledger is distributed to a plurality of computing nodes in a network.

12. The non-transitory computer readable medium of claim 8, wherein the instructions cause the computer to further perform operations comprising:
generating payroll information for a predetermined period of time, the payroll information associated with the first ledger account, and
transmitting, over the network, the payroll information associated with the first ledger account for display on a client display device.

13. The non-transitory computer readable medium of claim 8, wherein the instructions cause the computer to further perform operations comprising: verifying that the third party account owns the first payment prior to recording, in the encrypted ledger, the change in ownership from the third party account to the first ledger account.

14. The non-transitory computer readable medium of claim 11, wherein the first computing device is one of the plurality of computing nodes.

15. A computer implemented method for processing cryptographic transactions on a blockchain, comprising:
with one or more processors, generating a ledger having a plurality of ledger accounts, wherein the ledger is distributed to a plurality of computing nodes in a network, where in at least one ledger account comprising transaction data and payroll information, the transaction data comprising a transaction date, a transaction amount, and a transaction identifier, the transaction data arranged in data fields comprising assets, liabilities, cash flow, account receivables, revenue and expenses of the ledger account;
receiving, from a first computing device associated with a first ledger account, a first data entry for an amount due from a third party account;
generating an electronic invoice based on the first data entry;
transmitting the electronic invoice to a second computing device, the second computing device associated with the third party account;
receiving, from the second computing device, a request code to transfer a first payment with a cryptographic currency;
recording, in the ledger, a change in ownership of the cryptographic currency from the third party account to the first ledger account upon receipt of the request code; and
updating the first ledger account to reflect the transfer of the first payment with cryptographic currency.

16. The computer-implemented method of claim 15, comprising:
generating the payroll information for a predetermined period of time, the payroll information associated with the first ledger account, and
transmitting, over the network, the payroll information associated with the first ledger account for display on a client display device.

17. The computer-implemented method of claim 15, comprising: hashing the transaction data using a hashing algorithm prior to recording in the ledger.

18. The computer-implemented method of claim 15, wherein the third party account is a ledger account.

19. The computer-implemented method of claim 15, wherein the first computing device is one of the plurality of computing nodes.

20. The computer-implemented method of claim 15, comprising: verifying that the third party account owns the cryptographic currency prior to recording, in the encrypted ledger, the change in ownership from the third party account to the first ledger account.
